(19) United States
(12) Patent Application Publication
(10) Pub. No.: US 2023/0141260 A1
(43) Pub. Date: May 11, 2023

(54) ANTIREFLECTIVE GLASS ARTICLES WITH A POROSITY-GRADED LAYER AND METHODS OF MAKING THE SAME

(71) Applicant: Corning Incorporated, Corning, NY (US)

(72) Inventors: Haixing Chen, Shanghai (CN); Ling Chen, Shanghai (CN); Jiangwei Feng, Ithaca, NY (US); Meng Qin, Shanghai (CN); Jianqiang Zhu, Shanghai (CN)

(21) Appl. No.: 17/918,239

(22) PCT Filed: Apr. 13, 2021
(86) PCT No.: PCT/US2021/026993

§ 371 Date: Oct. 11, 2022

Related U.S. Application Data
(60) Provisional application No. 63/013,262, filed on Apr. 21, 2020.

(51) Int. Cl. C09D 5/00; C03C 3/064

(52) U.S. Cl. CPC C09D 5/006; C03C 3/064; C03C 2217/285; C03C 2218/111; C03C 2217/213

(57) ABSTRACT

A glass article is provided (and methods of making the same) that includes: a glass substrate comprising a thickness and a first primary surface; and a porosity-graded layer that extends from the first primary surface of the substrate to a first depth within the substrate. The first depth is from about 250 nm to about 3000 nm. The porosity-graded layer comprises a plurality of pores having an average pore size from about 5 nm to 100 nm. The article comprises a single-side average reflectance of less than 9% at an incident angle of 60 degrees across a spectrum from 350 nm to 2000 nm. Further, the porosity-graded layer comprises a surface porosity at the first primary surface and a bulk porosity at the first depth, the surface porosity greater than the bulk porosity.

### CROSS-REFERENCE TO RELATED APPLICATIONS

This application claims the benefit of priority under 35 U.S.C. § 119 of U.S. Provisional Application Ser. No. 63/013,262 filed on Apr. 21, 2020, the content of which is relied up on and incorporated herein by reference in its entirety.

### FIELD

The present disclosure generally relates to glass articles with a porosity-graded layer and methods of making the same, particularly such glass articles with antireflective (AR) properties, such as low reflectance at normal, near-normal and wide angles up to 60 degrees.

### BACKGROUND

Anti-reflection surfaces are used in display devices such as LCD screens, tablets, smartphones, OLEDs and touch screens to avoid or reduce specular reflection of ambient light. Reduction of specular reflection is often a desired property in touch-sensitive electronic devices, electronic ink readers, electronic whiteboards, and other portable LCD panels, especially when these devices are used in various lighting conditions. Other electronic devices that employ schemes to reduce specular reflection include optical instruments, automotive interior displays, optical lenses, laptop computers, and other electronic display devices. Further, many of these display devices require anti-reflection properties for multiple users and observers, many of which are located at non-acute incident angles.

Typically, the cover substrates employed in these devices exhibit anti-reflection properties with antiglare surface, single- and multi-layer coatings. For example, a multi-layer coating structure that includes alternating high and low refractive index layers can be deposited on a substrate to imbue it with antireflective properties. However, the composition and thicknesses of each of these layers within the multi-layer structure must be carefully controlled to obtain the desired, antireflective optical properties. Further, the processes typically employed to develop these multi-layer coating structures, e.g., physical vapor deposition (PVD) and chemical vapor deposition (CVD) processes, are time- and cost-intensive. In addition, many of these multi-layer coatings can enable acceptable anti-reflective properties at normal and near-normal incident angles, but fail to deliver anti-reflective properties over a wider range of non-acute incident angles.

Other optical coating structures characterized by variable refractive index values have been used with display device substrates to achieve anti-reflective properties over a wider range of incident viewing angles. These structures have been made through various approaches, including reactive ion etching (RIE), microsphere arraying, and co-evaporative coating deposition and etching processes. However, all of these processes are time-intensive, high in cost, and usually require complex equipment and high temperature processing.

Accordingly, there is a need for antireflective articles and methods of making the same that result in articles suitable for display devices with desired antireflective properties over a wide range of incident angles. Further, there is a need for such articles that can be made with processes that are relatively low in cost and duration.

### SUMMARY

According to an aspect of the disclosure, a glass article is provided that includes: a glass substrate comprising a thickness and a first primary surface; and a porosity-graded layer that extends from the first primary surface of the substrate to a first depth within the substrate. The first depth is from about 250 nm to about 3000 nm. The porosity-graded layer comprises a plurality of pores having an average pore size from about 5 nm to 100 nm. The article comprises a single-side average reflectance of less than 9% at an incident angle of 60 degrees across a spectrum from 350 nm to 2000 nm. Further, the porosity-graded layer comprises a surface porosity at the first primary surface and a bulk porosity at the first depth, the surface porosity greater than the bulk porosity.

According to an aspect of the disclosure, a glass article is provided that includes: a glass substrate comprising a thickness and a first primary surface; and a porosity-graded layer that extends from the first primary surface of the substrate to a first depth within the substrate. The first depth is from about 250 nm to about 3000 nm. The porosity-graded layer comprises a plurality of pores having an average pore size from about 5 nm to 100 nm. The porosity-graded layer comprises a surface porosity at the first primary surface and a bulk porosity at the first depth, the surface porosity greater than the bulk porosity. Further, the porosity-graded layer comprises a refractive index as a function of depth within the substrate, n_{PGL}(z), from the first primary surface to the first depth, given by

n²_{PGL}(z)=n²_{substrate}(1−fₚₒᵣₑ)+n²ₐᵢᵣ*fₚₒᵣₑ,

where n_{substrate} is the refractive index of the glass substrate, nₐᵢᵣ is the refractive index of air, and fₚₒᵣₑ is the volume fraction of the plurality of pores at the depth, z.

According to another aspect of the disclosure, a method of making a glass article is provided that includes: providing a silica-saturated solution; filtering the silica-saturated solution to remove insoluble silica particles from the silica-saturated solution and form a filtrated solution; and immersing a glass substrate comprising a thickness and a first primary surface with the filtrated solution, the immersing conducted to form a porosity-graded layer that extends from the first primary surface of the substrate to a first depth within the substrate. The silica-saturated solution comprises SiO₂ gel, H₂SiF₆, H₃BO₃ or CaCl₂), de-ionized H₂O, and an optional amount of HCl. The first depth in the substrate is from about 250 nm to about 3000 nm. The porosity-graded layer comprises a plurality of pores having an average pore size from about 5 nm to 100 nm. Further, the porosity-graded layer comprises a surface porosity at the first primary surface and a bulk porosity at the first depth, the surface porosity greater than the bulk porosity.

Additional features and advantages will be set forth in the detailed description which follows, and will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the disclosure as it is claimed.

The accompanying drawings are included to provide a further understanding of principles of the disclosure, and are incorporated in, and constitute a part of, this specification. The drawings illustrate one or more embodiments and, together with the description, serve to explain, by way of example, principles and operation of the disclosure. It is to be understood that various features of the disclosure disclosed in this specification and in the drawings can be used in any and all combinations. By way of non-limiting examples, the various features of the disclosure may be combined with one another according to the following aspects.

### BRIEF DESCRIPTION OF THE DRAWINGS

These and other features, aspects and advantages of the present disclosure are better understood when the following detailed description of the disclosure is read with reference to the accompanying drawings, in which:

FIG. 1 is a cross-sectional, schematic view of an antireflective glass article, according to an aspect of the disclosure.

FIG. 2A is a cross-sectional, schematic view of the porosity-graded layer of an antireflective glass article, according to an aspect of the disclosure.

FIG. 2B is a schematic plot of the refractive index of the porosity-graded layer of the antireflective glass article depicted in FIG. 2A.

FIG. 3 is a flow chart schematic of a method of making an antireflective glass article, according to an aspect of the disclosure.

FIG. 4A is a scanning electron microscope (SEM) image of a cross-section of an antireflective glass article, according to an aspect of the disclosure.

FIG. 4B is a higher magnification view of the SEM image of FIG. 4A.

FIG. 5A is an atomic force microscope (AFM), two-dimensional image of a primary surface of an antireflective glass article, according to an aspect of the disclosure.

FIG. 5B is an AFM, three-dimensional image of the primary surface of the antireflective glass article depicted in FIG. 5A.

FIG. 6A is a plot of double-side transmittance as a function of wavelength at incident angles of 0 degrees, 30 degrees, 45 degrees and 60 degrees for a control glass article, a glass article comprising a multi-layer antireflective layer, and an antireflective glass article according to the disclosure and as depicted in FIGS. 4A-5B.

FIG. 6B is a plot of double-side reflectance as a function of wavelength at incident angles of 0 degrees, 30 degrees, 45 degrees and 60 degrees for the same articles depicted in FIG. 6A.

FIGS. 7A-7C are SEM images of cross-sections of antireflective glass articles of the disclosure with porosity-graded layers processed at 25° C., 40° C. and 60° C., respectively.

FIG. 8 is a plot of single-side average transmittance (from 8 degrees to 60 degrees incidence) and single-side reflectance, both as a function of the thickness of the porosity-graded layer of the antireflective articles depicted in FIGS. 7A-7C, as measured at incident angles of 8 degrees, 30 degrees and 60 degrees.

FIG. 9A is an SEM image of a cross-section of an antireflective glass article, according to an aspect of the disclosure.

FIG. 9B is a higher magnification view of the SEM image of FIG. 9A.

FIG. 10A is a plot of single-side reflectance as a function of wavelength at incident angles of 0 degrees, 30 degrees, and 60 degrees for a control glass article, a glass article comprising a multi-layer antireflective layer, and an antireflective glass article according to the disclosure and as depicted in FIGS. 9A-9B.

FIG. 10B is a plot of double-side and single-side transmittance as a function of wavelength, as averaged over incident angles from 0 degrees to 60 degrees for the same articles depicted in FIG. 10A.

### DETAILED DESCRIPTION

In the following detailed description, for purposes of explanation and not limitation, example embodiments disclosing specific details are set forth to provide a thorough understanding of various principles of the present disclosure. However, it will be apparent to one having ordinary skill in the art, having had the benefit of the present disclosure, that the present disclosure may be practiced in other embodiments that depart from the specific details disclosed herein. Moreover, descriptions of well-known devices, methods and materials may be omitted so as not to obscure the description of various principles of the present disclosure. Finally, wherever applicable, like reference numerals refer to like elements.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as used herein for example, up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order. Accordingly, where a method claim does not actually recite an order to be followed by its steps, or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

As used herein, the singular forms “a,” “an” and “the” include plural referents unless the context clearly dictates otherwise. Thus, for example, reference to a “component” includes aspects having two or more such components, unless the context clearly indicates otherwise.

As used herein, the terms “pore size,” “pore diameter,” “average pore size” and “average pore diameter” are used interchangeably to refer to an average pore size of the porosity-graded layer of the glass articles of the disclosure that is determined on a volumetric basis. The average pore size or average pore diameter is determined according to a gas adsorption method or an effective refractive index method, as understood by those of ordinary skill in the field of the disclosure.

As used herein, the term “porosity” refers to the volume fraction (%) of the plurality of pores of the porosity-graded layer at a specified location of the porosity within the layer or as an average porosity of the entire porosity-graded layer. For example, “surface porosity” refers to the porosity of the plurality of pores in the porosity-graded layer at the first primary surface of the glass substrate of the antireflective glass article. Similarly, “bulk porosity” refers to the porosity of the plurality of pores in the porosity-graded layer at the first depth of the porosity-graded layer within the substrate of the antireflective glass article. In addition, “average porosity” refers to the average porosity of the plurality of pores within the entire porosity-graded layer, i.e., as spanning from the primary surface of the substrate defining the layer to its depth within the substrate.

As used herein, the term “transmittance” refers to the percentage of incident light power in a given wavelength range of a material (e.g., article, substrate, or optical film or portion thereof). The term “reflectance” refers to the percentage of incident light power that is reflected from a material (e.g., an article, substrate, or optical film or portion thereof) over a given range of wavelengths. Transmittance and reflectance are measured using a specific line width. As used herein, “average transmittance” refers to the average amount of incident light power transmitted through a material over a defined range of wavelengths. As used herein, “average reflectance” refers to the amount of average incident optical power reflected by a material. Unless otherwise noted, the reflectance and transmittance are measured through both primary surfaces of the substrate or article and designated “double side”. In some instances, however, the reflectance and transmittance values in the disclosure are designated as “single side” to refer to these values as measured at the primary surface of the substrate having a porosity-graded layer. In these “single side” measurements, a refractive index matching oil (or other known method) is coupled to the opposing primary surface to eliminate the reflectance of this back surface.

As used herein, the “average surface roughness,” “surface roughness,” “average surface roughness (Rₐ),” and “surface roughness (Rₐ)” are used interchangeably to refer to the surface roughness of a primary surface of a substrate of an antiglare article of the disclosure. This surface roughness (Rₐ) is calculated by first obtaining a roughness profile, which has been filtered from raw profile data of the primary surface according to principles understood by those of ordinary skill in the field of the disclosure. With the roughness profile in hand, the surface roughness (Rₐ) is measured according to the following equation:

$$Ra = \frac{1}{n} {\sum }_{i = 1}^{n} \vert {y}_{i} \vert$$

where the roughness profile contains n ordered, equally spaced points along the profile, and yᵢ is the vertical distance from the mean line of the profile to the i^{th} data point.

Aspects of the disclosure generally pertain to anti-reflective glass articles and methods of making the same, particularly glass articles with a porosity-graded layer and a glass substrate. These glass articles have antireflective properties, such as low reflectance and/or high transmittance at normal, near-normal and wide angles up to 60 degrees. The porosity-graded layer can have a depth from about 250 nm to about 3000 nm, and a plurality of pores having an average pore size from about 5 nm to about 100 nm. Further, the porosity-graded layer has a porosity at the surface of the substrate that exceeds the porosity of the porosity-graded layer at its depth within the substrate. In addition, the porosity of the porosity-graded layer can vary continuously from the surface of the substrate to its depth within the substrate, thus exhibiting a varying refractive index as a function of its varying porosity. A method of making these antireflective glass articles includes steps of preparing a silica-saturated solution and filtering insoluble silica particles out of it. The method also includes immersing a glass substrate in the filtrated silica-saturated solution to form a porosity-graded layer in the glass substrate. The silica-saturated solution can include SiO₂ gel, H₂SiF₆, H₃BO₃ or CaCl₂), de-ionized H₂O, and an optional amount of HCl.

The antireflective glass articles of the disclosure, and the methods of making them, demonstrate significant advantages over conventional antireflective articles (e.g., glass substrates with multi-layer antireflective coatings) and the methods of making them. The methods of the disclosure, for example, can be employed to develop a porosity-graded layer within a glass substrate, thus resulting in the in situ formation of an antireflective article. Another advantage of the AR glass articles of the disclosure is that they can possess AR properties across a broadband spectrum (e.g., inclusive of ultraviolet, visible and infrared spectra) at normal, near-normal and wide incident angles. A further advantage of the methods of the disclosure employed to make these AR glass articles is that these methods are relatively simple, short in duration and low in cost as they include wet chemical processes that do not require expensive processing equipment or significant capital outlays. Further, these methods are not susceptible to significant environmental concerns as they can be conducted at relatively low temperatures and under non-vacuum conditions. Still further, it is believed that the methods outlined in the disclosure are robust in terms of producing AR glass articles with the desired optical properties, and amenable to easy scale up for mass production.

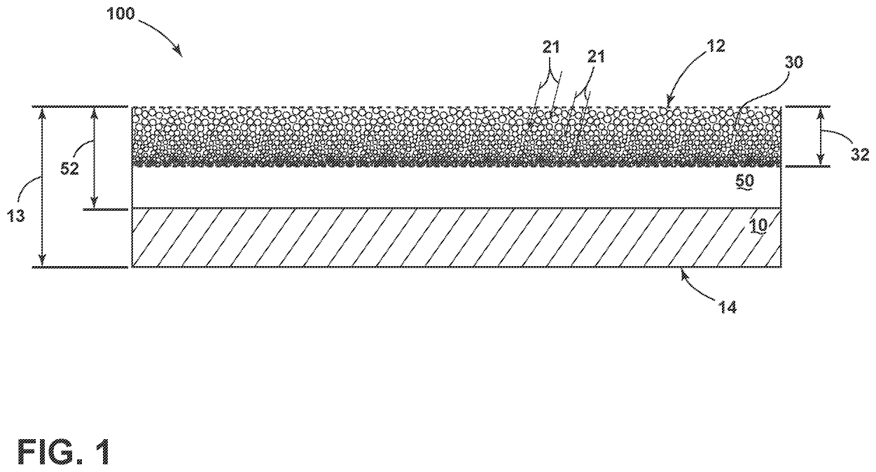

Referring to FIG. 1, an antireflective glass article 100 is depicted as including a glass substrate 10 with a plurality of primary surfaces 12 and 14, and a thickness 13. The glass article 100 also includes a porosity-graded layer 30, as defined by the primary surface 12. In some embodiments, the porosity-graded layer 30 is formed from or otherwise part of the substrate 10, as shown in FIG. 1. In some implementations (not shown), the porosity-graded layer 30 is defined by the primary surface 14 and extends a first depth 32 within the substrate 10. Further, in some implementations, the porosity-graded layer 30 is defined by both of primary surfaces 12 and 14.

As also depicted in FIG. 1, the porosity-graded layer 30 of the antireflective glass article 100 includes a plurality of pores 21. The plurality of pores 21 within the porosity-graded layer 30 can have an average pore size from about 5 nm to about 100 nm. According to implementations of the article 100, the average pore size of the plurality of pores 21 can range from about 5 nm to about 100 nm, from about 5 nm to about 90 nm, from about 5 nm to about 80 nm, from about 5 nm to about 70 nm, from about 5 nm to about 60 nm, from about 5 nm to about 50 nm, from about 10 nm to about 100 nm, from about 10 nm to about 90 nm, from about 10 nm to about 80 nm, from about 10 nm to about 70 nm, from about 10 nm to about 60 nm, from about 10 nm to about 50 nm, and all average pore size ranges or sub-ranges defined by any two of the preceding pore size ranges. For example, the average pore size of the plurality of pores 21 can be 5 nm, 10 nm, 15 nm, 20 nm, 25 nm, 30 nm, 35 nm, 40 nm, 45 nm, 50 nm, 55 nm, 60 nm, 65 nm, 70 nm, 75 nm, 80 nm, 85 nm, 90 nm, 95 nm, 100 nm, and all pore size values between these average pore sizes.

As further depicted in FIG. 1, the porosity-graded layer 30 of the antireflective glass article 100 has a surface porosity at the first primary surface 12 of the substrate 10 and a bulk porosity at the first depth 32 such that the surface porosity is greater than the bulk porosity. In some implementations of the antireflective glass article 100, the surface porosity of the porosity-graded layer 30 is greater than its bulk porosity at the first depth 32 by at least a factor of 20, at least a factor of 15, at least a factor of 10, or at least a factor of 5. For example, the surface porosity of the porosity-graded layer can be greater than its bulk porosity at the first depth 32 by a factor of 30, 25, 20, 15, 10, 5, and all factors between these levels.

As also depicted in FIG. 1, the first depth 32 of the porosity-graded layer 30 of the antireflective article 100 can range from about 250 nm to about 3000 nm. In some implementations, the first depth 32 can range from about 250 nm to about 3000 nm, from about 250 nm to about 2500 nm, from about 250 nm to about 2000 nm, from about 250 nm to about 1500 nm, from about 250 nm to about 1000 nm, from about 500 nm to about 3000 nm, from about 500 nm to about 2500 nm, from about 500 nm to about 2000 nm, from about 500 nm to about 1500 nm, from about 500 nm to about 1000 nm, and all ranges and sub-ranges of the first depth 32 between or otherwise within the preceding ranges. For example, the first depth 32 of the porosity-graded layer 30 can be 250 nm, 300 nm, 350 nm, 400 nm, 450 nm, 500 nm, 550 nm, 600 nm, 650 nm, 700 nm, 750 nm, 800 nm, 850 nm, 900 nm, 950 nm, 1000 nm, 1100 nm, 1200 nm, 1300 nm, 1400 nm, 1500 nm, 1600 nm, 1700 nm, 1800 nm, 1900 nm, 2000 nm, 2100 nm, 2200 nm, 2300 nm, 2400 nm, 2500 nm, 2600 nm, 2700 nm, 2800 nm, 2900 nm, 3000 nm, and all values of the first depth 32 between the preceding depth levels of the first depth 32 within the substrate 10.

Referring again to FIG. 1, embodiments of the antireflective article 100 have a porosity-graded layer 30 with a first primary surface 12 that can be characterized by an average surface roughness (Rₐ) from about 1 nm to about 20 nm. In some implementations, the surface roughness (Rₐ) of the first primary surface 12 can range from 1 nm to about 100 nm, from about 1 nm to about 75 nm, from about 1 nm to about 50 nm, from about 1 nm to about 40 nm, from about 1 nm to about 30 nm, from about 1 nm to about 20 nm, from about 1 nm to about 10 nm, from about 5 nm to about 100 nm, from about 5 nm to about 75 nm, from about 5 nm to about 50 nm, from about 5 nm to about 40 nm, from about 5 nm to about 30 nm, from about 5 nm to about 20 nm, from about 5 nm to about 10 nm, and all ranges and sub-ranges of the average surface roughness (Rₐ) of the first primary surface 12 between or otherwise within the preceding ranges. For example, the first primary surface 12 can have a surface roughness (Rₐ) of 1 nm, 2 nm, 3 nm, 4 nm, 5 nm, 6 nm, 7 nm, 8 nm, 9 nm, 10 nm, 15 nm, 20 nm, 25 nm, 30 nm, 35 nm, 40 nm, 45 nm, 50 nm, 60 nm, 70 nm, 80 nm, 90 nm, 100 nm, and all values of the surface roughness (Rₐ) of the first primary surface 12 between the preceding values of average surface roughness (Rₐ) of the first primary surface 12.

Referring again to the first primary surface 12 of the porosity-graded layer 30 associated with the antireflective glass article 100 depicted in FIG. 1, the average surface roughness (Rₐ) can be measured as surface roughness using an interferometer. Unless otherwise specified, an interferometer is employed to determine average surface roughness (Rₐ) and the ZYGO® NEWVIEW™ 7300 Optical Surface Profiler manufactured by ZYGO® Corporation is deemed to be suitable for this purpose. While the interferometer is employed to characterize the surface roughness of the primary surface 12 of the antireflective articles 100 of the disclosure, the imaging can be further supplemented by an AFM, as deemed necessary by those of ordinary skill in the field of the disclosure, for particularly low surface roughness levels (i.e., <100 nm) observed. Unless otherwise noted, the average surface roughness (Rₐ) is reported as a mean surface roughness.

According to embodiments of the antireflective glass article 100 depicted in FIG. 1, the article is characterized by low reflectance at normal, near-normal and wide angles up to 60 degrees across a spectrum from 350 nm to 2000 nm. For example, the antireflective article 100 is characterized by a single-side average reflectance of less than 10% at an incident angle of 60 degrees. As such, the antireflective article 100 can be characterized by a single-side average reflectance at an incident angle of 60 degrees of less than 10%, 9%, 8%, 7%, 6%, 5%, 4%, 3%, 2%, 1%, 0.5%, and all single-side reflectance levels between the preceding reflectance upper bounds. As another example, the antireflective article 100 can be characterized by a single-side average reflectance of less than 5% at an incident angle of 45 degrees. As such, the antireflective article 100 can be characterized by a single-side average reflectance at an incident angle of 45 degrees of less than 5%, 4%, 3%, 2%, 1%, 0.9%, 0.8%, 0.7%, 0.6%, 0.5% and all single-side reflectance levels between the preceding reflectance upper bounds. In another instance, the antireflective article 100 can be characterized by a single-side average reflectance of less than 5% at an incident angle of 30 degrees. As such, the antireflective article 100 can be characterized by a single-side average reflectance at an incident angle of 30 degrees of less than 5%, 4%, 3%, 2%, 1%, 0.9%, 0.8%, 0.7%, 0.6%, 0.5% and all single-side reflectance levels between the preceding reflectance upper bounds. In another instance, the antireflective article 100 can be characterized by a single-side average reflectance of less than 4% at an incident angle of 8 degrees (i.e., a near-normal incident angle). Accordingly, the antireflective article 100 can be characterized by a single-side average reflectance at an incident angle of 8 degrees of less than 4%, 3.5%, 3%, 2.5%, 2%, 1.5%, 1%, 0.9%, 0.8%, 0.7%, 0.6%, 0.5% and all single-side reflectance levels between the preceding reflectance upper bounds. In another instance, the antireflective article 100 can be characterized by a single-side average reflectance of less than 5%, 2.5%, or less than 1.5% at an incident angle of 8 degrees, 30 degrees or 60 degrees across the visible spectrum from 360 nm to 800 nm. Accordingly, the antireflective article 100 can be characterized by a single-side average reflectance at an incident angle of 8 degrees, 30 degrees or 60 degrees of less than 5%, 4.5%, 4%, 3.5%, 3%, 2.5%, 2%, 1.5%, 1.4%, 1.3%, 1.2%, 1.1%, 1%, 0.9%, 0.8%, 0.7%, 0.6%, 0.5% and all single-side reflectance levels between the preceding reflectance upper bounds, as measured across the visible spectrum from 360 nm to 800 nm.

According to implementations of the antireflective glass article 100 depicted in FIG. 1, the article is characterized by high transmittance at normal, near-normal and wide angles up to 60 degrees across a spectrum from 350 nm to 2000 nm. For example, the antireflective article 100 is characterized by a single-side average transmittance of greater than 85%, 87.5%, or 90% at an incident angle of 30 degrees, 45 degrees and/or 60 degrees. As such, the antireflective article 100 can be characterized by a single-side average transmittance at an incident angle of 30, 45 or 60 degrees of greater than 85%, 86%, 87%, 88%, 89%, 90%, 91%, 92%, 93%, 94%, 95%, 96%, 97%, 98%, 99%, and all single-side transmittance levels between the preceding transmittance lower bounds.

Those with ordinary skill in the field of the disclosure will also recognize that the foregoing low reflectance and high transmittance values of the antireflective glass article 100 depicted in FIG. 1 observed from near-normal to wide angle incidence angles (e.g., from 8 to 60 degrees) in a single-side arrangement across a broadband spectrum from 350 nm to 2000 nm and/or visible spectrum from 360 nm to 800 nm are also observed in a double-side arrangement through both primary surfaces 12, 14 of the substrate 10. While the reflectance levels remain low (<10%) and the transmittance levels remain high (>85%), these values can be about 0.5× to 5× higher or lower than the comparable reflectance and transmittance values of the single-side arrangement, respectively, given the additional optical interface in such double-side configurations.

Referring again to FIG. 1, the glass substrate 10 of the antireflective glass article 100 can be configured with a multi-component glass composition having about 40 mol % to 80 mol % silica and a balance of one or more other constituents, e.g., alumina, calcium oxide, sodium oxide, boron oxide, etc. In some implementations, the bulk composition of the glass substrate 10 is selected from the group consisting of an aluminosilicate glass, a borosilicate glass and a phosphosilicate glass. In other implementations, the bulk composition of the glass substrate 10 is selected from the group consisting of an aluminosilicate glass, a borosilicate glass, a phosphosilicate glass, a soda lime glass, an alkali aluminosilicate glass, and an alkali aluminoborosilicate glass. In further implementations, the glass substrate 10 is a glass-based substrate, including but not limited to, glass-ceramic materials that comprise a glass component at about 90% or greater by weight and a ceramic component.

In one embodiment of the antireflective glass article 100 depicted in FIG. 1, the glass substrate 10 has a bulk composition that comprises an alkali aluminosilicate glass that comprises alumina, at least one alkali metal and, in some embodiments, greater than 50 mol SiO₂, in other embodiments, at least 58 mol %, and in still other embodiments, at least 60 mol % SiO₂, wherein the ratio (Al₂O₃ (mol %)+B₂O₃ (mol %))/Σ alkali metal modifiers (mol %)>1, where the modifiers are alkali metal oxides. This glass, in particular embodiments, comprises, consists essentially of, or consists of: about 58 mol % to about 72 mol % SiO₂; about 9 mol % to about 17 mol % Al₂O₃; about 2 mol % to about 12 mol % B₂O₃; about 8 mol % to about 16 mol % Na₂O; and 0 mol % to about 4 mol % K₂O, wherein the ratio (Al₂O₃ (mol %)+B₂O₃ (mol %))/Σ alkali metal modifiers (mol %)>1, where the modifiers are alkali metal oxides.

In another embodiment of the antireflective glass article 100, as shown in FIG. 1, the glass substrate 10 has a bulk composition that comprises an alkali aluminosilicate glass comprising, consisting essentially of, or consisting of: about 61 mol % to about 75 mol % SiO₂; about 7 mol % to about 15 mol % Al₂O₃; 0 mol % to about 12 mol % B₂O₃; about 9 mol % to about 21 mol Na₂O; 0 mol % to about 4 mol % K₂O; 0 mol % to about 7 mol % MgO; and 0 mol % to about 3 mol % CaO.

In yet another embodiment, the glass substrate 10 has a bulk composition that comprises an alkali aluminosilicate glass comprising, consisting essentially of, or consisting of: about 60 mol % to about 70 mol % SiO₂; about 6 mol % to about 14 mol % Al₂O₃; 0 mol % to about 15 mol % B₂O₃; 0 mol % to about 15 mol % Li₂O; 0 mol % to about 20 mol % Na₂O; 0 mol % to about 10 mol % K₂O mol % to about 8 mol % MgO; 0 mol % to about 10 mol % CaO; 0 mol % to about 5 mol % ZrO₂; 0 mol % to about 1 mol % SnO₂; 0 mol % to about 1 mol % CeO₂; less than about 50 ppm As₂O₃; and less than about 50 ppm Sb₂O₃, wherein 12 mol %≤Li₂O+Na₂O+K₂O≤20 mol % and 0 mol %≤MgO+Ca≤10 mol %.

In still another embodiment, the glass substrate 10 has a bulk composition that comprises an alkali aluminosilicate glass comprising, consisting essentially of, or consisting of: about 64 mol % to about 68 mol % SiO₂; about 12 mol % to about 16 mol % Na₂O; about 8 mol % to about 12 mol % Al₂O₃; 0 mol % to about 3 mol % B₃O₃; about 2 mol % to about 5 mol % K₂O; about 4 mol % to about 6 mol % MgO; and 0 mol % to about 5 mol % CaO, wherein: 66 mol %≤SiO₂+B₂O₃CaO≤69 mol %; Na₂O+K₂O+B₂O₃+MgO+CaO+SrO>10 mol %; 5 mol %≤MgO+CaO+SrO≤8 mol %; (Na₂O+B₂O₃)—Al₂O₃≤2 mol %; 2 mol %≤Na₂O—Al₂O₃≤6 mol %; and 4 mol %≤(Na₂O+K₂O)—Al₂O₃≤10 mol %.

In other embodiments, the glass substrate 10 has a bulk composition that comprises SiO₂, Al₂O₃, P₂O₅, and at least one alkali metal oxide (R₂O), wherein 0.75>[(P₂O₅ (mol %)+R₂O (mol %))/M₂O₃ (mol %)]≤1.2, where M₂O₃═Al₂O₃+B₂O₃. In some embodiments, [(P₂O₅ (mol %)+R₂O (mol %))/M₂O₃ (mol %)]=1 and, in some embodiments, the glass does not include B₂O₃ and M₂O₃═Al₂O₃. The glass substrate comprises, in some embodiments: about 40 mol % to about 70 mol % SiO₂; 0 mol % to about 28 mol % B₂O₃; about 0 mol % to about 28 mol % Al₂O₃; about 1 mol % to about 14 mol % P₂O₅; and about 12 mol % to about 16 mol % R₂O. In some embodiments, the glass substrate comprises: about 40 mol % to about 64 mol % SiO₂; 0 mol % to about 8 mol % B₂O₃; about 16 mol % to about 28 mol % Al₂O₃; about 2 mol % to about 12 mol % P₂O₅; and about 12 mol % to about 16 mol % R₂O. The glass substrate 10 may further comprise at least one alkaline earth metal oxide such as, but not limited to, MgO or CaO.

In some embodiments, the glass substrate 10 has a bulk composition that is substantially free of lithium; i.e., the glass comprises less than 1 mol % Li₂O and, in other embodiments, less than 0.1 mol % Li₂O and, in other embodiments, 0.01 mol % Li₂O, and in still other embodiments, 0 mol % L₂O. In some embodiments, such glasses are free of at least one of arsenic, antimony, and barium; i.e., the glass comprises less than 1 mol % and, in other embodiments, less than 0.1 mol %, and in still other embodiments, 0 mol % of As₂O₃, Sb₂O₃, and/or BaO.

In other embodiments of the antireflective glass article 100 depicted in FIG. 1, the glass substrate 10 has a bulk composition that comprises, consists essentially of or consists of a glass composition Corning® Eagle XG® glass, Corning® Gorilla® glass, Corning® Gorilla® Glass 2, Corning® Gorilla® Glass 3, Corning® Gorilla® Glass 4 or Corning® Gorilla® Glass 5.

According to other embodiments, the glass substrate 10 of the antireflective glass article 100 depicted in FIG. 1 can possess an ion-exchangeable glass composition that is strengthened by either chemical or thermal means that are known in the art. In one embodiment, the glass substrate is chemically strengthened by ion exchange. In this process, metal ions at or near a primary surface 12 and/or primary surface 14 of the glass substrate 10 are exchanged for larger metal ions having the same valence as the metal ions in the glass substrate. The exchange is generally carried out by contacting the glass substrate 10 with an ion exchange medium such as, for example, a molten salt bath that contains the larger metal ion. The metal ions are typically monovalent metal ions such as, for example, alkali metal ions. In one non-limiting example, chemical strengthening of a glass substrate 10 that contains sodium ions by ion exchange is accomplished by immersing the glass substrate 10 in an ion exchange bath comprising a molten potassium salt such as potassium nitrate (KNO₃) or the like. In one particular embodiment, the ions in the surface layer of the glass substrate 10 and the larger ions are monovalent alkali metal cations, such as Li⁺ (when present in the glass), Na⁺, K⁺, Rb⁺, and Cs⁺. Alternatively, monovalent cations in the surface layer of the glass substrate 10 may be replaced with monovalent cations other than alkali metal cations, such as Ag or the like.

In these embodiments of the antireflective glass article 100 depicted in FIG. 1, the replacement of small metal ions by larger metal ions in the ion exchange process creates a compressive stress region 50 in the glass substrate 10 that extends from the primary surface 12 to a depth 52 (referred to as the “depth of layer”) that is under compressive stress. It should also be understood that a compressive stress region can be formed in the glass substrate that extends from the primary surface 14 to a depth (not shown in FIG. 1) that is comparable in nature to the compressive stress region 50. More particularly, this compressive stress at the primary surface of the glass substrate is balanced by a tensile stress (also referred to as “central tension”) within the interior of the glass substrate. In some embodiments, the primary surface 12 of the glass substrate 10 described herein, when strengthened by ion exchange, has a compressive stress of at least 350 MPa, and the region under compressive stress extends to a depth 52, i.e., depth of layer, of at least 15 μm below the primary surface 12.

Ion exchange processes are typically carried out by immersing the glass substrate 10 in a molten salt bath containing the larger ions to be exchanged with the smaller ions in the glass. It will be appreciated by those skilled in the art that parameters for the ion exchange process, including, but not limited to, bath composition and temperature, immersion time, the number of immersions of the glass in a salt bath (or baths), use of multiple salt baths, and additional steps such as annealing, washing, and the like, are generally determined by the composition of the glass and the desired depth of layer and compressive stress of the glass as a result of the strengthening operation. By way of example, ion exchange of alkali metal-containing glasses may be achieved by immersion in at least one molten bath containing a salt such as, but not, limited to, nitrates, sulfates, and chlorides of the larger alkali metal ion. The temperature of the molten salt bath typically is in a range from about 380° C. up to about 450° C., while immersion times range from about 15 minutes up to about 16 hours. However, temperatures and immersion times different from those described above may also be used. Such ion exchange treatments, when employed with a glass substrate 10 having an alkali aluminosilicate glass composition, result in a compressive stress region 50 having a depth 52 (depth of layer) ranging from about 10 μm up to at least 50 μm with a compressive stress ranging from about 200 MPa up to about 800 MPa, and a central tension of less than about 100 MPa.

As the etching processes that can be employed to create the porosity-graded layer 30 of the antireflective glass article 100, according to some embodiments, can remove alkali metal ions from the glass substrate 10 that would otherwise be replaced by a larger alkali metal ion during an ion exchange process, a preference exists for developing a compressive stress region 50 in the antireflective glass article 100 after the formation and development of the porosity-graded layer 30. In other embodiments, a compressive stress region 50 can be developed in the glass substrate 10 prior to development of the porosity-graded layer 30 to a depth 52 sufficient to account for some loss in the depth of layer in the region 50 associated with the various treatments associated with forming the porosity-graded layer 30, as outlined below.

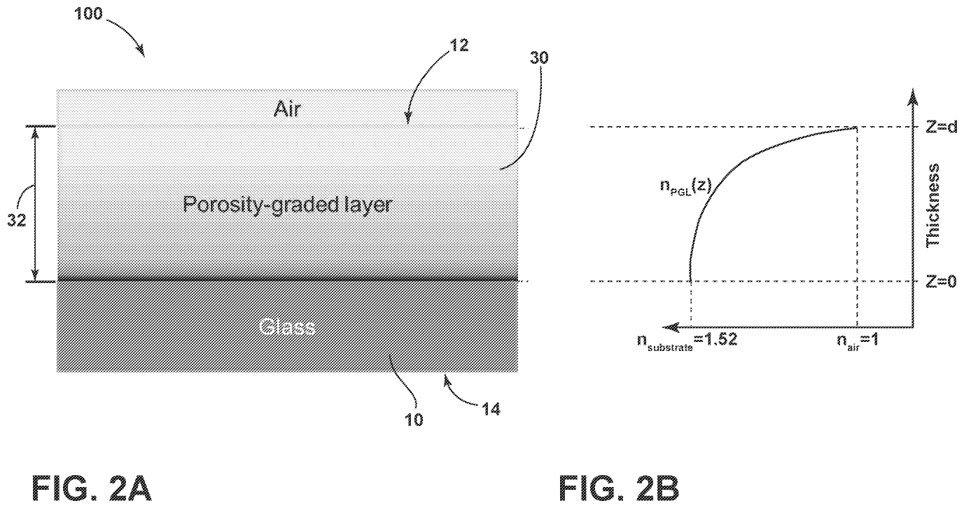

Referring now to FIG. 2A, a cross-sectional, schematic view of the porosity-graded layer 30 of an antireflective glass article 100 is shown. As is evident from FIG. 2A, the porosity-graded layer 30 possesses a porosity gradient that spans the depth of the layer 30 from the first primary surface 12 to the first depth 32. Further, the porosity gradient present in the layer 30 results in a refractive index gradient, which can enable the antireflective properties of the antireflective article 100. In some implementations, antireflective properties are obtained across a broadband spectrum (i.e., from 350 nm to 2000 nm) at various incident angles (e.g., from 8 to 60 degrees) by ensuring that the porosity-graded layer 30 does not exhibit any sharp boundaries of refractive index and/or porosity levels. According to these implementations, the porosity in the porosity-graded layer 30 varies continuously from the first primary surface 12 to the first depth 32.

According to an implementation of the antireflective article 100 (see FIG. 1), a parabolic porosity and refractive index gradient can be developed within the porosity-graded layer 30 to achieve the foregoing low reflectance and/or high transmittance levels across a broadband spectrum at near-normal to wide angle incident angles according to the schematic depicted in FIG. 2B. In such implementations, the porosity-graded layer 30 comprises a refractive index as a function of depth within the substrate, n_{PGL}(z), from the first primary surface 12 to the first depth 32, as given by the following equation, Equation (1):

n²_{PGL}(z)=n²_{substrate}(1−fₚₒᵣₑ)+n²ₐᵢᵣ*fₚₒᵣₑ (1)

where substrate is the refractive index of the glass substrate 10 (e.g., n_{substrate}=1.52), nₐᵢᵣ is the refractive index of air (i.e., nₐᵢᵣ=1.0), and fₚₒᵣₑ is the volume fraction of the plurality of pores at the depth, z. Further, as is evident from Equation (1) and FIG. 2B, the pore volume fₚₒᵣₑ, of the porosity-graded layer 30 increases throughout the layer from the first depth 32 toward the first primary surface 12. Hence, the refractive index of the porosity-graded layer 30 approaches but does not equal the refractive index of air at the first surface 12, nₐᵢᵣ=1.0. Similarly, the refractive index of the porosity-graded layer 30 approaches but does not equal the refractive index of the glass substrate 10 at the first depth 32, n_{substrate}=1.52. According to some embodiments, the porosity-graded layer 30 can be configured such that fₚₒᵣₑ is from 0.01% to about 30%, fₚₒᵣₑ is from 0.1% to ab out 25%, or fₚₒᵣₑ is from about 0.5% to about 20%. For example the pore volume fₚₒᵣₑ, of the porosity-graded layer 30 can be 0.01% 0.05%, 0.1%, 0.5%, 1%, 2%, 3%, 4%, 5%, 10%, 15%, 20%, 25%, 30%, and all pore volume me levels between these values, at any position, or as an average, from the first primary surface 12 to the first depth 32.

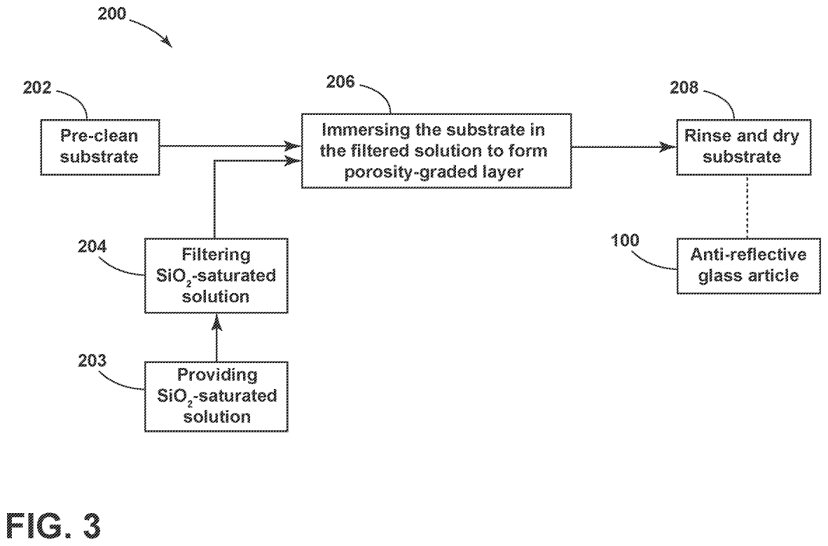

Referring now to FIG. 3, a schematic flow chart is provided that depicts a method 200 of making an antireflective glass article 100 (see FIG. 1), according to an embodiment of the disclosure. As shown in FIG. 3, the method includes the following steps: a step 203 of providing a silica-saturated solution; a step 204 of filtering the silica-saturated solution to remove insoluble silica particles from the silica-saturated solution and form a filtrated solution; and a step 206 of immersing a glass substrate (e.g., glass substrate 10 as shown in FIG. 1) comprising a thickness 13 and a first primary surface 12 with the filtrated solution, the immersing conducted to form a porosity-graded layer 30 that extends from the first primary surface 12 of the substrate 10 to a first depth 32 within the substrate. An optional step of the method 200 is a step 202 of pre-cleaning the substrate 10 before the step 206 of immersing the glass substrate. A further optional step of the method 200 is a step 208 of rinsing and drying the substrate 10 after the immersion step 206. Ultimately, the method 200 results in the formation of an antireflective glass article 100 (see FIG. 1 and earlier description) after completion of step 206 and optional step 208.

Referring again to the method 200 depicted in FIG. 3, the silica-saturated solution includes SiO₂ gel, H₂SiF₆, H₃BO₃ and/or CaCl₂), de-ionized H₂O, and an optional amount of HCl. The first depth 32 of the porosity-graded layer 30 within the substrate 10 is from about 250 nm to about 3000 nm. The porosity-graded layer 30 includes a plurality of pores 21 having an average pore size from about 5 nm to 100 nm. Further, the porosity-graded layer 30 can be characterized by a surface porosity at the first primary surface 12 and a bulk porosity at the first depth 32, the surface porosity greater than the bulk porosity.

Still referring to the method 200 depicted in FIG. 3, the step 202 of pre-cleaning the substrate 10 can be conducted to ensure that the primary surfaces 12, 14 of the substrate 10 are sufficiently clean prior to the development of the porosity-graded layer 30. For example, step 202 can be conducted to clean the substrate 10 with a detergent in an ultrasound bath at ambient temperature to an elevated temperature below boiling, e.g., from about 25° C. to about 90° C., for 5 minutes to 60 minutes. With regard to step 203, this step can be conducted, according to some implementations of the method 200, by providing a silica-saturated solution in the form of a reaction solution. The reaction solution can include from about 3% to 5% SiO₂ gel, about 1.5 to 2.0 mol/L H₂SiF₆, about 20 to 40 mmol/L H₃BO₃ and/or CaCl₂), 0 to 0.12 mol/L HCl, and a balance of de-ionized H₂O (by weight). For example, step 203 can be conducted according to three sub-steps. A first sub-step of step 203 can include adding the SiO₂ gel to an about 30 to 32 wt % H₂SiF₆ solution with mechanical stirring at ambient temperature for about 10 to 24 hours, or until the SiO₂ gel is completely dissolved and saturated within the H₂SiF₆ solution. A second sub-step of step 203 of the method 200 can include adding the specified amounts of the H₃BO₃ and HCl aqueous solutions into the SiO₂-saturated, H₂SiF₆ solution, and mixing these constituents by a vigorous stirring action at ambient temperature for about 10 to 30 minutes. A third sub-step of step 203 of the method 200 can include mechanically agitating the mixed solution of the second sub-step in a water bath set at from about 25° C. to about 60° C. for about 10 to 40 minutes. At this point, step 204 of the method 200 can be conducted to filter all insoluble particles from the solution of step 203 to obtain a substantially clear solution. Further, the substrates that have been subjected to a pre-cleaning step 202 can then be immersed according to step 206 in the filtrated solution of step 204 from about 25° C. to about 60° C. for about 2 to 60 minutes with mechanical agitation. In some embodiments, step 206 can be conducted by vertically arranging the pre-cleaned substrates in a cassette or other similar arrangement. Finally, as part of step 208, the substrates that have been previously subjected to the immersion of step 206 can then be rinsed with deionized water and dried in an oven from about 30° C. to about 75° C. for about 15 minutes to 60 minutes. Upon completion of the method 200 depicted in FIG. 3, particularly steps 202-208, antireflective articles 100 are formed, as depicted in FIG. 1 and outlined earlier.

One of the unique advantages of the method 200 depicted in FIG. 3 and described above is that the development of the porosity-graded layer occurs quickly (e.g., from about 2 to 60 minutes) and at a relatively low temperature (from about 25° C. to 60° C.). Without being bound by theory, this phenomenon may be the result of the participation of the F⁻ ions from the aqueous, filtrated solution. As one of the ingredients in the solution, H₂SiF₆ can be hydrolyzed to SiO₂ and HF. The hydrolysis product of H₂SiF₆ can attack the network of SiO₂ and accelerate the corrosion process. However, the H₃BO₃ and/or CaCl₂) can capture F⁻ ions in the reacted solution and maintain the HF concentration at a low level, which can help form the porosity-graded layer and avoid a process that devolves into pure etching. Moreover, the saturated SiO₂ gel in the H₂SiF₆ solution can also suppress the hydrolysis of H₂SiF₆, thus maintaining a low concentration of HF in the filtrated solution.

### EXAMPLES

The following examples describe various features and advantages provided by the disclosure, and are in no way intended to limit the invention and appended claims.

### Example 1

According to this example, Corning® Gorilla® Glass 5 glass substrates were subjected to a method of making an antireflective glass article as outlined earlier in the disclosure. In particular, a group of these glass substrates was cleaned with a detergent in an ultrasound bath at ambient temperature to an elevated temperature below boiling, e.g., from about 25° C. for about 5 minutes. Next, a silica-saturated solution was prepared with the following constituents and concentration levels: from about 3% to 5% SiO₂ gel, about 1.5 to 2.0 mol/L H₂SiF₆, about 20 to 40 mmol/L H₃BO₃ or CaCl₂), 0 to 0.12 mol/L HCl, and a balance of de-ionized H₂O (by weight). Further, the SiO₂ gel was added to the 30 to 32 wt % H₂SiF₆ solution with mechanical stirring at ambient temperature for about 10 to 24 hours, or until the SiO₂ gel was completely dissolved and saturated within the H₂SiF₆ solution. Next, the specified amounts of the H₃BO₃ and HCl aqueous solutions were added into the SiO₂-saturated, H₂SiF₆ solution, and then mixed by a vigorous stirring action at ambient temperature for about 10 to 30 minutes. The resulting solution was then mechanically agitated in a water bath set at from about 25° C. to about 60° C. for about 10 to 40 minutes. At this point, all of the insoluble particles from the solution were filtered to obtain a substantially clear solution. The pre-cleaned glass substrates were then immersed in the filtrated solution at about 40° C. for about 10 minutes with mechanical agitation. In addition, the immersed glass substrates were rinsed with deionized water and dried in an oven at 50° C. for 30 minutes. Upon completion of the method of this example, the treated AR glass articles (designated “Ex. 1”) exhibited a porosity-graded layer.

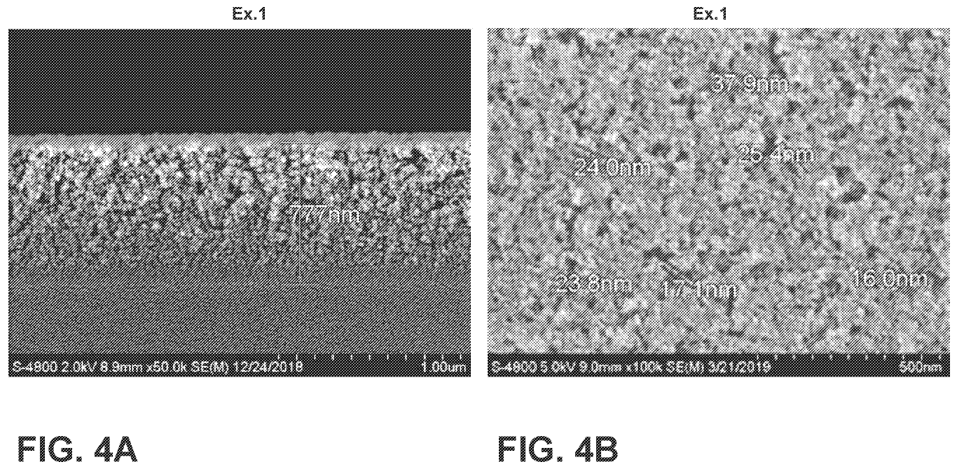

Referring now to FIG. 4A, a scanning electron microscope (SEM) image is provided of a cross-section of an antireflective glass article of this example (“Ex. 1”). FIG. 4B is a higher magnification view of the SEM image of FIG. 4A. As demonstrated by FIGS. 4A and 4B, the porosity-graded layer of these AR glass articles has a depth of about 780 nm. Further, the density and the porosity of the porosity-graded layer gradually varies from the primary surface of the substrate to its full depth at about 780 nm. In addition, it is also evident from FIGS. 4A and 4B that the average pore sizes of the porosity-graded layer vary from about 16 nm to about 40 nm within the depth of the layer, with larger pore sizes toward the primary surface of the substrate.

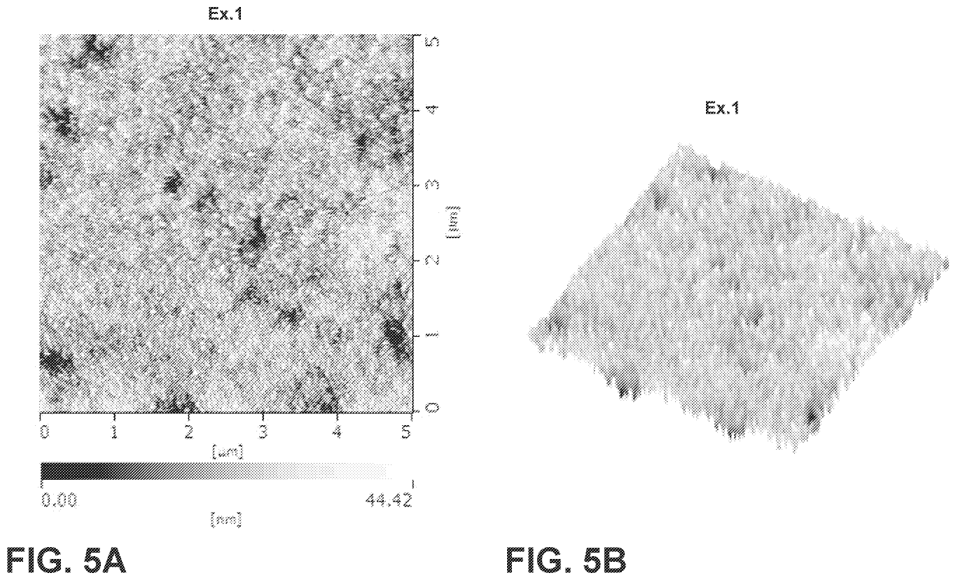

Referring now to FIG. 5A, an atomic force microscope (AFM), two-dimensional image of a primary surface of the antireflective glass article of this example is provided (“Ex. 1”). Further, FIG. 5B is an AFM, three-dimensional image of the primary surface of the antireflective glass article, Ex. 1, as depicted in FIG. 5A. As is evident from FIGS. 5A and 5B, the primary surface of the porosity-graded layer of the antireflective glass article of this example is smooth, with an average surface roughness (Rₐ) of 5.33 nm.

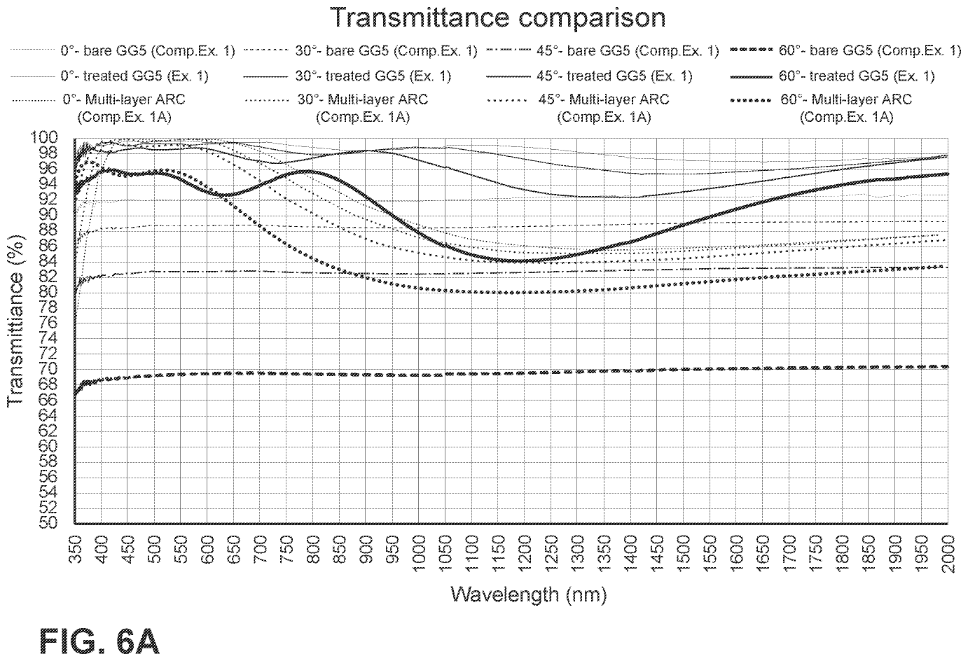

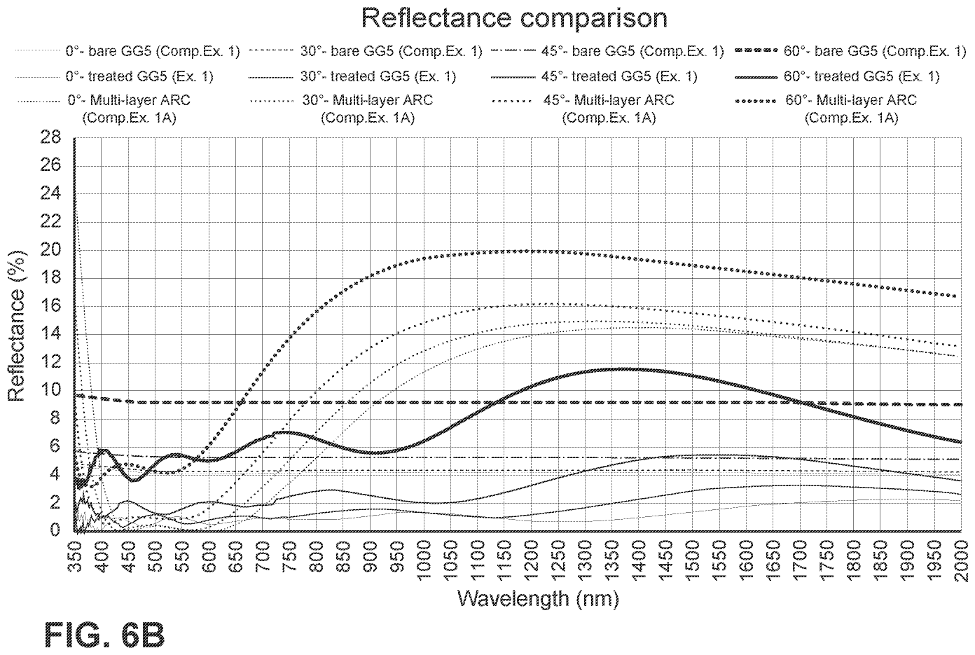

Referring now to FIG. 6A, a plot is provided of double-side transmittance (%) as a function of wavelength (nm) at incident angles of 0 degrees, 30 degrees, 45 degrees and 60 degrees for a control article with untreated Corning® Gorilla® Glass 5 glass substrates (“Comp. Ex. 1”), antireflective glass articles with Corning® Gorilla® Glass 5 glass substrates according to this example (“Ex. 1”), and a control antireflective glass article that comprises a multi-layer antireflective coating (“Comp. Ex. 1A”). As for the latter, this group of samples, Comp. Ex. 1A, employs a conventional multi-layer AR coating over a glass substrate. The multi-layer AR coating includes a low index SiO₂ layer (n=1.47), a high index TiO₂ layer (n=2.6) and a medium index indium tin oxide (ITO), SnO₂ or ZrO₂ layer (n˜2), as set forth in U.S. Pat. No. 6,074,730, the salient portions of which are incorporated by reference in this disclosure. FIG. 6B is a plot of the double-side reflectance (%) of these same samples as a function of wavelength at incident angles of 0 degrees, 30 degrees, 45 degrees and 60 degrees.

As is evident from FIGS. 6A and 6B, the antireflective glass articles of this example, Ex. 1, exhibited antireflective properties in broadband (e.g., from 350 nm to 2000 nm) across a wide range of incident angles (0 degrees to 60 degrees). In particular, the average transmittance of the AR glass articles of this example, Ex. 1, is 99.5%, which stands as a significant improvement over the average transmittance of the untreated control group, Comp. Ex. 1, measured at 92.1%. At wider incident angles, similar improvements in transmittance are observed. In particular, the average transmittance of the AR glass articles of this example, Ex. 1, is 97.5%, 95.9% and 91.1% at incident angles of 30 degrees, 45 degrees and 60 degrees, respectively, which stands as a significant improvement over the average transmittance of the untreated control group, Comp. Ex. 1, measured at 88.8%, 82.8% and 69.7%, over the same incident angles, respectively. Similar improvements in average reflectance levels are also observed, from near-normal to wide incident angles. In particular, the average reflectance of the AR glass articles of this example, Ex. 1, is 1.24%, 1.85%, 3.41% and 7.9% at incident angles of 8 degrees, 30 degrees, 45 degrees and 60 degrees, respectively, which stands as a significant improvement over the average reflectance of the untreated control group, Comp. Ex. 1, measured at 4.34%, 4.5%, 5.4% and 9.35%, over the same incident angles, respectively.

With regard to the conventional AR articles that comprise a multi-layer AR coating, Comp. Ex. 1A, the AR glass articles of this example demonstrate better transmittance and reflectance properties, as is evident from FIGS. 6A and 6B. Notably, the AR glass articles of this example, Ex. 1, display superior transmittance and reflectance properties at low wavelengths from 350 nm to 400 nm and higher wavelengths from 650 nm to 2000 nm, across wide incident angles of 30 degrees, 45 degrees and 60 degrees.

The transmittance and reflectance data of the AR glass articles of Ex. 1 and glass articles of Comp. Ex. 1 from FIGS. 6A and 6B, and other optical data generated as part of this example across the visible spectrum (i.e., from 360 nm to 800 nm), are provided below in Table 1. As is evident from Table 1, the average reflectance at an incident angle of 8 degrees is 0.47% and 0.62% in a single-side and double-side configuration of the AR glass articles of this example (Ex. 1), respectively, which are significantly lower than the comparably measured average reflectance values of the control glass articles (Comp. Ex. 1), 4.26% and 7.87%, respectively. In addition, when the incident angle is increased to 60 degrees, the average reflectance at an incident angle of 8 degrees is 1.3% and 3.1% in a single-side and double-side configuration of the AR glass articles of this example (Ex. 1), respectively, which are significantly lower than the comparably measured average reflectance values of the control glass articles (Comp. Ex. 1), 8.8% and 14.6%, respectively. In addition, the average transmittance levels of the AR glass articles of this example (Ex. 1) are 95.7% and 99.3% in a single-side and double-side configuration, respectively, which are comparable in performance to the control group of AR glass articles with a multi-layer AR coating (Comp. Ex. 1A) and higher than the control glass articles (Comp. Ex. 1) of this example, measured at 92.1%.

TABLE 1

| | Porosity- | Average Transmittance | | Average Reflectance (%) (360-800 nm) | | | | | |
|---|---|---|---|---|---|---|---|---|---|
| | graded | (%) (360-800 nm) | | 8° | | 30° | | 60° | |
| | layer | single | double | single | double | single | double | single | double |
| Sample ID | thickness | side | side | side | side | side | side | side | side |
| Comp. Ex. 1 | N/A | 92.1 | | 4.26 | 7.87 | 4.33 | 7.95 | 8.8 | 14.6 |
| Ex. 1 | 777 nm | 95.73 | 99.34 | 0.47 | 0.62 | 0.28 | 0.63 | 1.3 | 3.07 |

### Example 2

According to this example, Corning® Gorilla® Glass 5 glass substrates were subjected to a method of making an antireflective glass article as outlined earlier in the disclosure. In particular, a group of these glass substrates was cleaned with a detergent in an ultrasound bath at ambient temperature to an elevated temperature below boiling, e.g., from about 25° C. for about 5 minutes. Next, a silica-saturated solution was prepared with the following constituents and concentration levels: from about 3% to 5% SiO₂ gel, about 1.5 to 2.0 mol/L H₂SiF₆, about 20 to 40 mmol/L H₃BO₃ or CaCl₂), 0 to 0.12 mol/L HCl, and a balance of de-ionized H₂O (by weight). Further, the SiO₂ gel was added to the 30 to 32 wt % H₂SiF₆ solution with mechanical stirring at ambient temperature for about 10 to 24 hours, or until the SiO₂ gel was completely dissolved and saturated within the H₂SiF₆ solution. Next, the specified amounts of the H₃BO₃ and HCl aqueous solutions were added into the SiO₂-saturated, H₂SiF₆ solution, and then mixed by a vigorous stirring action at ambient temperature for about 10 to 30 minutes. The resulting solution was then mechanically agitated in a water bath set at from about 25° C. to about 60° C. for about 10 to 40 minutes. At this point, all of the insoluble particles from the solution were filtered to obtain a substantially clear solution. The pre-cleaned glass substrates were then immersed in the filtrated solution at 25° C., 40° C. or 60° C. for about 10 minutes with mechanical agitation. In addition, the immersed glass substrates were rinsed with deionized water and dried in an oven at 50° C. for 30 minutes. Upon completion of the method of this example, each of the treated AR glass articles, as treated at an immersion temperature of 25° C., 40° C. or 60° C., exhibited a porosity-graded layer (designated “Ex. 1A”, “Ex. 1B” and “Ex. 1C”, respectively).

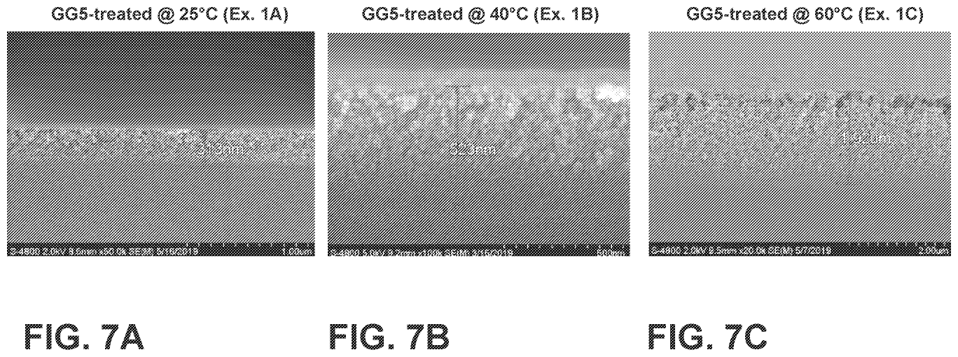

Referring now to FIGS. 7A-7C, SEM images are provided of cross-sections of antireflective glass articles of this example with porosity-graded layers processed at 25° C., 40° C. and 60° C., respectively. As is evident from these figures, the thicknesses (i.e., as comparable to the first depth 32 of the porosity-graded layer 30 of the AR article 100 shown in FIG. 1) of the porosity-graded layers of these AR glass articles processed at 25° C., 40° C. and 60° C., Exs. 1A-1C, were measured at 313 nm, 523 nm and 1.92 μm, respectively. Hence, it is evident that the depth of the porosity-graded layer of the AR glass articles of this example increases as a function of the immersion temperature employed, e.g., in step 206 of the method 200 depicted in FIG. 3 and outlined earlier.

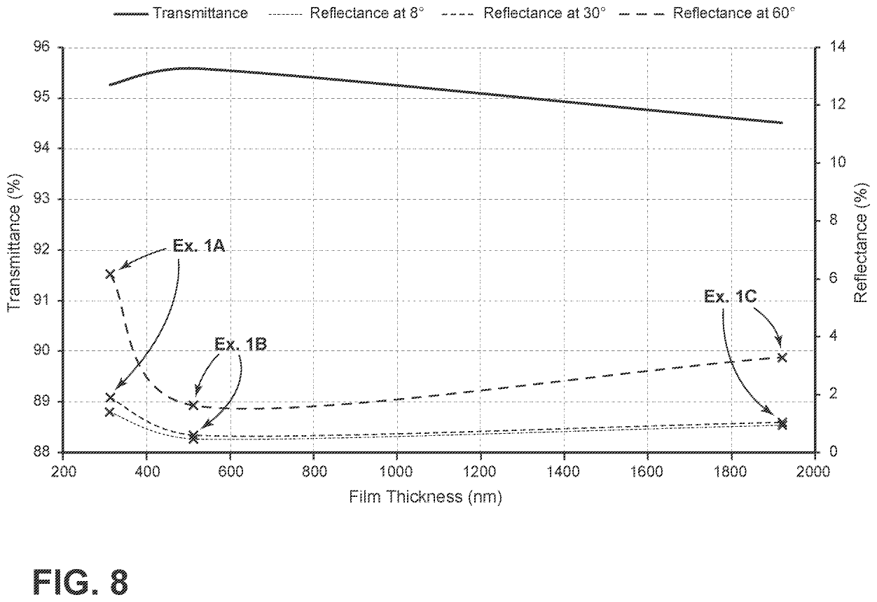

Referring now to FIG. 8, a plot is provided of single-side average transmittance (from 8 degrees to 60 degrees incidence) and single-side reflectance as a function of porosity-graded layer thickness at incident angles of 8 degrees, 30 degrees and 60 degrees for the AR glass articles depicted in FIGS. 7A-7C (i.e., Exs. 1A-1C). As is evident from FIG. 8, the optical performance of these AR glass articles only slightly varies as a function of porosity-graded layer thickness between these samples, Exs. 1A-1C, which were processed at immersion temperatures of 25° C., 40° C. and 60° C.

### Example 3

According to this example, Corning® Gorilla® Glass 3 glass substrates were subjected to a method of making an antireflective glass article as outlined earlier in the disclosure. In particular, a group of these glass substrates was cleaned with a detergent in an ultrasound bath at ambient temperature to an elevated temperature below boiling, e.g., from about 25° C. for about 5 minutes. Next, a silica-saturated solution was prepared with the following constituents and concentration levels: from about 3% to 5% SiO₂ gel, about 1.5 to 2.0 mol/L H₂SiF₆, about 20 to 40 mmol/L H₃BO₃ or CaCl₂), 0 to 0.12 mol/L HCl, and a balance of de-ionized H₂O (by weight). Further, the SiO₂ gel was added to the 30 to 32 wt % H₂SiF₆ solution with mechanical stirring at ambient temperature for about 10 to 24 hours, or until the SiO₂ gel was completely dissolved and saturated within the H₂SiF₆ solution. Next, the specified amounts of the H₃BO₃ and HCl aqueous solutions were added into the SiO₂-saturated, H₂SiF₆ solution, and then mixed by a vigorous stirring action at ambient temperature for about 10 to 30 minutes. The resulting solution was then mechanically agitated in a water bath set at from about 25° C. to about 60° C. for about 10 to 40 minutes. At this point, all of the insoluble particles from the solution were filtered to obtain a substantially clear solution. The pre-cleaned glass substrates were then immersed in the filtrated solution at about 40° C. for about 10 minutes with mechanical agitation. In addition, the immersed glass substrates were rinsed with deionized water and dried in an oven at 50° C. for 30 minutes. Upon completion of the method of this example, the treated AR glass articles (designated “Ex. 2”) exhibited a porosity-graded layer.

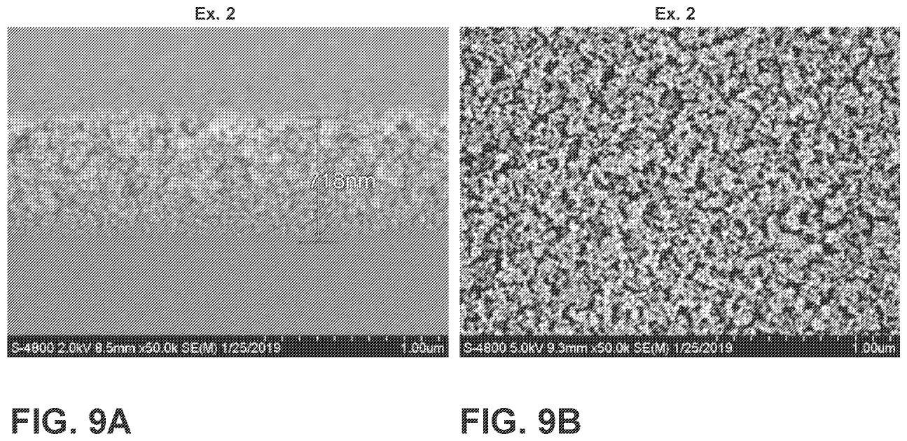

Referring now to FIG. 9A, an SEM image is provided of a cross-section of an antireflective glass article prepared according to this example (Ex. 2). Further, FIG. 9B is a higher magnification view of the SEM image of FIG. 9A. As demonstrated by FIGS. 9A and 9B, the porosity-graded layer of these AR glass articles has a depth of about 718 nm. Further, the density and the porosity of the porosity-graded layer gradually varies from the primary surface of the substrate to its full depth at about 718 nm. In addition, it is also evident from FIGS. 9A and 9B that the average pore sizes of the porosity-graded layer vary, and are below about 100 nm throughout the depth of the layer.

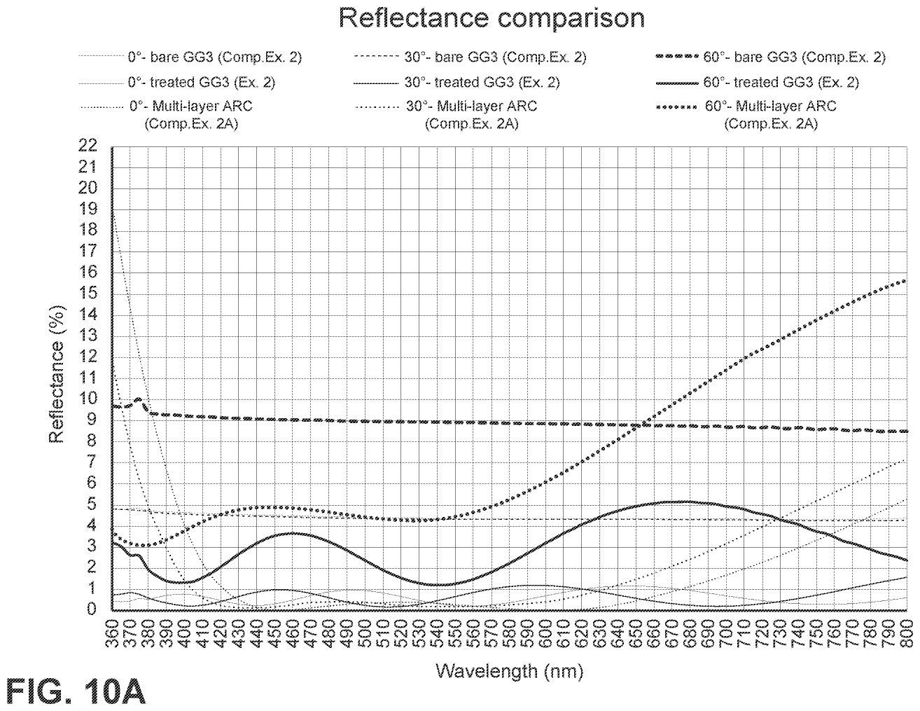

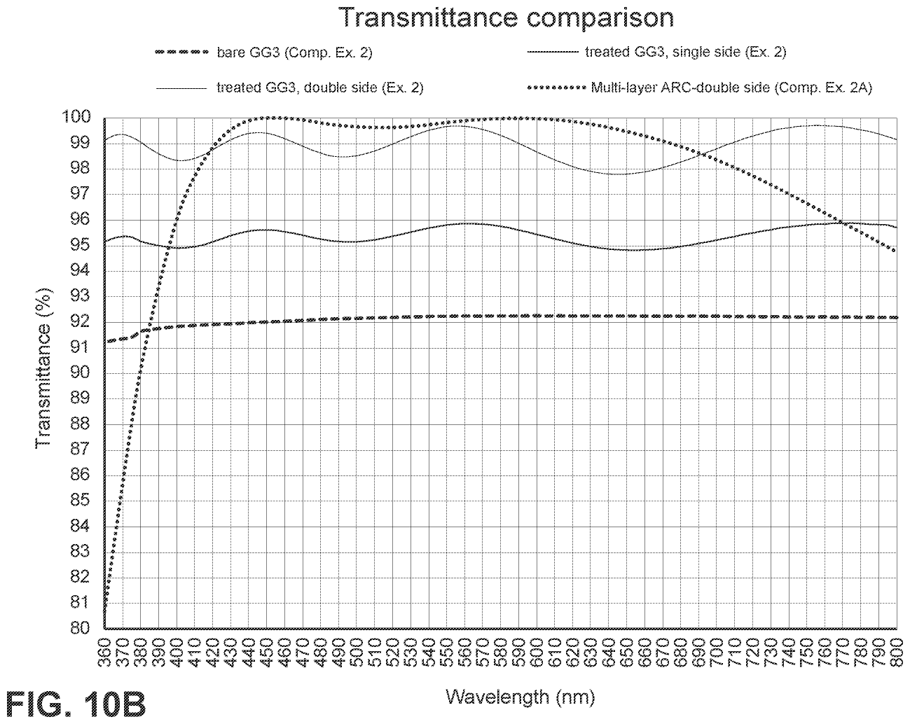

Referring now to FIG. 10A, a plot is provided of double-side reflectance (%) as a function of wavelength (i.e., across the visible spectrum, 360 nm to 800 nm) at incident angles of 0 degrees, 30 degrees, and 60 degrees for a control article with untreated Corning® Gorilla® Glass 3 glass substrates (“Comp. Ex. 2”), antireflective glass articles with Corning® Gorilla® Glass 5 glass substrates according to this example (“Ex. 2”), and a control antireflective glass article that comprises a multi-layer antireflective coating (“Comp. Ex. 2A”). As for the latter, this group of samples, Comp. Ex. 2A, employs a conventional multi-layer AR coating over a glass substrate. The multi-layer AR coating includes a low index SiO₂ layer (n=1.47), a high index TiO₂ layer (n=2.6) and a medium index indium tin oxide (ITO), SnO₂ or ZrO₂ layer (n˜2), as set forth in U.S. Pat. No. 6,074,730, the salient portions of which are incorporated by reference in this disclosure. Further, FIG. 10B is a plot of the double-side and single-side transmittance (%) of these same samples as a function of wavelength, as averaged over incident angles from 0 to 60 degrees.

As is evident from FIGS. 10A and 10B, the optical performance of the AR glass articles of this example (Ex. 2) are significantly improved over the untreated, control glass articles (Comp. Ex. 2). In particular, the AR glass articles of this example (Ex. 2) exhibited reflectance levels of 0.89%, 1.14% and 4.27% at incident angles of 8 degrees, 30 degrees and 60 degrees, respectively, over the visible spectrum. In comparison, the untreated control glass articles of this example (Comp. Ex. 2) exhibited reflectance levels of 4.24%, 4.37%, and 8.91% and the AR glass articles with a multi-layer AR coating (Comp. Ex. 2A) exhibited reflectance levels of 2.09%, 2.15% and 7.47%, all as measured at incident angles of 8 degrees, 30 degrees and 60 degrees, respectively. Further, the transmittance levels of the AR glass articles of this example (Ex. 2) were measured at 95.4% and 98.9% in single-side and double-side configurations, respectively. In comparison, the transmittance levels of the control, untreated glass samples and the control AR glass articles with a multi-layer AR coating were measured at 92.1% and 97.9%, respectively.

Embodiment 1. According to a first embodiment, a glass article is provided. The glass article comprises: a glass substrate comprising a thickness and a first primary surface; and a porosity-graded layer that extends from the first primary surface of the substrate to a first depth within the substrate. The first depth is from about 250 nm to about 3000 nm. The porosity-graded layer comprises a plurality of pores having an average pore size from about 5 nm to 100 nm. The article comprises a single-side average reflectance of less than 9% at an incident angle of 60 degrees across a spectrum from 350 nm to 2000 nm. The porosity-graded layer comprises a surface porosity at the first primary surface and a bulk porosity at the first depth, the surface porosity greater than the bulk porosity.

Embodiment 2. According to a second embodiment, the first embodiment is provided, wherein the article further comprises a single-side average reflectance of less than 5% at an incident angle of 45 degrees across a spectrum from 350 nm to 2000 nm.

Embodiment 3. According to a third embodiment, the first or second embodiment is provided, wherein the article further comprises a single-side average reflectance of less than 5% at an incident angle of 30 degrees across a spectrum from 350 nm to 2000 nm.

Embodiment 4. According to a fourth embodiment, any one of the first through third embodiments is provided, wherein the article further comprises a single-side average reflectance of less than 4% at an incident angle of 8 degrees across a spectrum from 350 nm to 2000 nm.

Embodiment 5. According to a fifth embodiment, any one of the first through fourth embodiments is provided, wherein the article further comprises a single-side average transmittance of greater than 90% at an incident angle of 30 degrees, 45 degrees or 60 degrees across a spectrum from 350 nm to 2000 nm.

Embodiment 6. According to a sixth embodiment, any one of the first through fifth embodiments is provided, wherein the article further comprises a single-side average reflectance of less than 1.5% at an incident angle of 8 degrees, 30 degrees or 60 degrees across a spectrum from 360 nm to 800 nm.

Embodiment 7. According to a seventh embodiment, any one of the first through sixth embodiments is provided, wherein the first primary surface comprises an average surface roughness (Rₐ) from about 1 nm to about 20 nm.

Embodiment 8. According to an eighth embodiment, any one of the first through seventh embodiments is provided, wherein the porosity-graded layer comprises a plurality of pores having an average pore size from about 10 nm to about 50 nm and a first depth from about 300 nm to about 1000 nm.

Embodiment 9. According to a ninth embodiment, a glass article is provided. The glass article comprises: a glass substrate comprising a thickness and a first primary surface; and a porosity-graded layer that extends from the first primary surface of the substrate to a first depth within the substrate. The first depth is from about 250 nm to about 3000 nm. The porosity-graded layer comprises a plurality of pores having an average pore size from about 5 nm to 100 nm. The porosity-graded layer comprises a surface porosity at the first primary surface and a bulk porosity at the first depth, the surface porosity greater than the bulk porosity. The porosity-graded layer comprises a refractive index as a function of depth within the substrate, n_{PGL}(z), from the first primary surface to the first depth, given by

n²_{PGL}(z)=n²_{substrate}(1−fₚₒᵣₑ)+n²ₐᵢᵣ*fₚₒᵣₑ,

where n_{substrate} is the refractive index of the glass substrate, nₐᵢᵣ is the refractive index of air, and fₚₒᵣₑ is the volume fraction of the plurality of pores at the depth, z.

Embodiment 10. According to a tenth embodiment, the ninth embodiment is provided, wherein fₚₒᵣₑ is from 0.5% to about 20%.

Embodiment 11. According to an eleventh embodiment, the ninth or tenth embodiment is provided, wherein the porosity in the porosity-graded layer varies continuously from the first primary surface to the first depth.

Embodiment 12. According to a twelfth embodiment, any one of the ninth through eleventh embodiments is provided, wherein the article comprises a single-side average reflectance of less than 9% at an incident angle of 60 degrees across a spectrum from 350 nm to 2000 nm.

Embodiment 13. According to a thirteenth embodiment, any one of the ninth through twelfth embodiments is provided, wherein the article further comprises a single-side average reflectance of less than 5% at an incident angle of 45 degrees, 30 degrees or 8 degrees across a spectrum from 350 nm to 2000 nm.

Embodiment 14. According to a fourteenth embodiment, any one of the ninth through thirteenth embodiments is provided, wherein the article further comprises a single-side average transmittance of greater than 90% at an incident angle of 30 degrees, 45 degrees or 60 degrees across a spectrum from 350 nm to 2000 nm.

Embodiment 15. According to a fifteenth embodiment, any one of the ninth through fourteenth embodiments is provided, wherein the article further comprises a single-side average reflectance of less than 1.5% at an incident angle of 8 degrees, 30 degrees or 60 degrees across a spectrum from 360 nm to 800 nm.

Embodiment 16. According to a sixteenth embodiment, any one of the ninth through fifteenth embodiments is provided, wherein the first primary surface comprises an average surface roughness (Rₐ) from about 1 nm to about 20 nm.

Embodiment 17. According to a seventeenth embodiment, any one of the ninth through sixteenth embodiments is provided, wherein the porosity-graded layer comprises a plurality of pores having an average pore size from about 10 nm to about 50 nm and a first depth from about 300 nm to about 1000 nm.

Embodiment 18. According to an eighteenth embodiment, a method of making a glass article is provided. The method comprises: providing a silica-saturated solution; filtering the silica-saturated solution to remove insoluble silica particles from the silica-saturated solution and form a filtrated solution; and immersing a glass substrate comprising a thickness and a first primary surface with the filtrated solution, the immersing conducted to form a porosity-graded layer that extends from the first primary surface of the substrate to a first depth within the substrate. The silica-saturated solution comprises SiO₂ gel, H₂SiF₆, H₃BO₃ or CaCl₂), de-ionized H₂O, and an optional amount of HCl. The first depth in the substrate is from about 250 nm to about 3000 nm. The porosity-graded layer comprises a plurality of pores having an average pore size from about 5 nm to 100 nm. The porosity-graded layer comprises a surface porosity at the first primary surface and a bulk porosity at the first depth, the surface porosity greater than the bulk porosity.

Embodiment 19. According to a nineteenth embodiment, the eighteenth embodiment is provided, wherein the immersing is conducted at 25° C. to 60° C. for about 2 minutes to about 60 minutes.

Embodiment 20. According to a twentieth embodiment, the eighteenth or nineteenth embodiment is provided, wherein the silica-saturated solution comprises from about 3% to 5% SiO₂ gel, about 1.5 to 2.0 mol/L H₂SiF₆, about 20 to 40 mmol/L H₃BO₃ or CaCl₂), 0 to 0.12 mol/L HCl, and a balance of de-ionized H₂O (by weight).

Embodiment 21. According to a twenty-first embodiment, any one of the eighteenth through twentieth embodiments is provided, wherein the first primary surface comprises an average surface roughness (Rₐ) from about 1 nm to about 20 nm.

Embodiment 22. According to a twenty-second embodiment, any one of the eighteenth through twenty-first embodiments is provided, wherein the porosity-graded layer comprises a plurality of pores having an average pore size from about 10 nm to about 50 nm and a first depth from about 300 nm to about 1000 nm.

Embodiment 23. According to a twenty-third embodiment, any one of the eighteenth through twenty-second embodiments is provided, wherein the article comprises a single-side average reflectance of less than 9% at an incident angle of 60 degrees across a spectrum from 350 nm to 2000 nm.

Embodiment 24. According to a twenty-fourth embodiment, any one of the eighteenth through twenty-third embodiments is provided, wherein the porosity-graded layer comprises a refractive index as a function of depth within the substrate, n_{PGL}(z), from the first primary surface to the first depth, given by

n²_{PGL}(z)=n²_{substrate}(1−fₚₒᵣₑ)+n²ₐᵢᵣ*fₚₒᵣₑ,

where n_{substrate} is the refractive index of the glass substrate, nₐᵢᵣ is the refractive index of air, and fₚₒᵣₑ is the volume fraction of the plurality of pores at the depth, z.

Embodiment 25. According to a twenty-fifth embodiment, any one of the eighteenth through twenty-fourth embodiments is provided, wherein fₚₒᵣₑ is from 0.5% to about 20%, and further wherein the porosity in the porosity-graded layer varies continuously from the first primary surface to the first depth.

Many variations and modifications may be made to the above-described embodiments of the disclosure without departing substantially from the spirit and various principles of the disclosure. All such modifications and variations are intended to be included herein within the scope of this disclosure and protected by the following claims.

1. A glass article, comprising:
a glass substrate comprising a thickness and a first primary surface; and
a porosity-graded layer that extends from the first primary surface of the substrate to a first depth within the substrate,
wherein the first depth is from about 250 nm to about 3000 nm,
wherein the porosity-graded layer comprises a plurality of pores having an average pore size from about 5 nm to 100 nm,
wherein the article comprises a single-side average reflectance of less than 9% at an incident angle of 60 degrees across a spectrum from 350 nm to 2000 nm, and
further wherein the porosity-graded layer comprises a surface porosity at the first primary surface and a bulk porosity at the first depth, the surface porosity greater than the bulk porosity.

2. The glass article of claim 1, wherein the article further comprises a single-side average reflectance of less than 5% at an incident angle of 45 degrees across a spectrum from 350 nm to 2000 nm.

3. The glass article of claim 1, wherein the article further comprises a single-side average reflectance of less than 5% at an incident angle of 30 degrees across a spectrum from 350 nm to 2000 nm.

4. (canceled)

5. The glass article of claim 1, wherein the article further comprises a single-side average transmittance of greater than 90% at an incident angle of 30 degrees, 45 degrees or 60 degrees across a spectrum from 350 nm to 2000 nm.

6. The glass article of claim 1, wherein the article further comprises a single-side average reflectance of less than 1.5% at an incident angle of 8 degrees, 30 degrees or 60 degrees across a spectrum from 360 nm to 800 nm.

7. The glass article of claim 1, wherein the first primary surface comprises an average surface roughness (Rₐ) from about 1 nm to about 20 nm.

8. The glass article of claim 1, wherein the porosity-graded layer comprises a plurality of pores having an average pore size from about 10 nm to about 50 nm and a first depth from about 300 nm to about 1000 nm.

9. A glass article, comprising:
a glass substrate comprising a thickness and a first primary surface; and
a porosity-graded layer that extends from the first primary surface of the substrate to a first depth within the substrate,
wherein the first depth is from about 250 nm to about 3000 nm,
wherein the porosity-graded layer comprises a plurality of pores having an average pore size from about 5 nm to 100 nm,
wherein the porosity-graded layer comprises a surface porosity at the first primary surface and a bulk porosity at the first depth, the surface porosity greater than the bulk porosity, and
further wherein the porosity-graded layer comprises a refractive index as a function of depth within the substrate, n_{PGL}(Z), from the first primary surface to the first depth, given by
n²_{PGL}(z)=n²_{substrate}(1−fₚₒᵣₑ)+n²ₐᵢᵣ*fₚₒᵣₑ,
where n_{substrate} is the refractive index of the glass substrate, nₐᵢᵣ is the refractive index of air, and fₚₒᵣₑ is the volume fraction of the plurality of pores at the depth, z.

10. The glass article of claim 9, wherein fₚₒᵣₑ is from 0.5% to about 20%.

11. The glass article of claim 9, wherein the porosity in the porosity-graded layer varies continuously from the first primary surface to the first depth.

12. The glass article of claim 9, wherein the article comprises a single-side average reflectance of less than 9% at an incident angle of 60 degrees across a spectrum from 350 nm to 2000 nm.

13. The glass article of claim 9, wherein the article further comprises a single-side average reflectance of less than 5% at an incident angle of 45 degrees, 30 degrees or 8 degrees across a spectrum from 350 nm to 2000 nm.

14. The glass article of claim 9, wherein the article further comprises a single-side average transmittance of greater than 90% at an incident angle of 30 degrees, 45 degrees or 60 degrees across a spectrum from 350 nm to 2000 nm.

15. (canceled)

16. The glass article of claim 9, wherein the first primary surface comprises an average surface roughness (Rₐ) from about 1 nm to about 20 nm.

17. The glass article of claim 9, wherein the porosity-graded layer comprises a plurality of pores having an average pore size from about 10 nm to about 50 nm and a first depth from about 300 nm to about 1000 nm.

18. A method of making a glass article, comprising:
providing a silica-saturated solution;
filtering the silica-saturated solution to remove insoluble silica particles from the silica-saturated solution and form a filtrated solution; and
immersing a glass substrate comprising a thickness and a first primary surface with the filtrated solution, the immersing conducted to form a porosity-graded layer that extends from the first primary surface of the substrate to a first depth within the substrate,
wherein the silica-saturated solution comprises SiO₂ gel, H₂SiF₆, H₃BO₃ or CaCl₂, de-ionized H₂O, and an optional amount of HCl,
wherein the first depth in the substrate is from about 250 nm to about 3000 nm,
wherein the porosity-graded layer comprises a plurality of pores having an average pore size from about 5 nm to 100 nm, and
further wherein the porosity-graded layer comprises a surface porosity at the first primary surface and a bulk porosity at the first depth, the surface porosity greater than the bulk porosity.

19. The method according to claim 18, wherein the immersing is conducted at 25° C. to 60° C. for about 2 minutes to about 60 minutes.

20. The method according to claim 18, wherein the silica-saturated solution comprises from about 3% to 5% SiO₂ gel, about 1.5 to 2.0 mol/L H₂SiF₆, about 20 to 40 mmol/L H₃BO₃ or CaCl₂, 0 to 0.12 mol/L HCl, and a balance of de-ionized H₂O (by weight).

21. (canceled)

22. (canceled)

23. The method according to claim 18, wherein the article comprises a single-side average reflectance of less than 9% at an incident angle of 60 degrees across a spectrum from 350 nm to 2000 nm.

24. The method according to claim 18, wherein the porosity-graded layer comprises a refractive index as a function of depth within the substrate, n_{PGL}(z), from the first primary surface to the first depth, given by
n²_{PGL}(z)=n²_{substrate}(1−fₚₒᵣₑ)+n²ₐᵢᵣ*fₚₒᵣₑ,
where n_{substrate} is the refractive index of the glass substrate, nₐᵢᵣ is the refractive index of air, and fₚₒᵣₑ is the volume fraction of the plurality of pores at the depth, z.

25. (canceled)
